(19) United States
(12) Patent Application Publication
(10) Pub. No.: US 2015/0010414 A1
(43) Pub. Date: Jan. 8, 2015

(54) STATOR, THREE-PHASE INDUCTION MOTOR, AND COMPRESSOR

(71) Applicant: Danfoss Tianjin Ltd., Tianjin (CN)

(72) Inventors: Weiping Tang, Tianjin (CN); Li Yao, Tianjin (CN); Wanzhen Liu, Tianjin (CN); Guangqiang Liu, Tianjin (CN); Yan Lin, Tianjin (CN); Zhenyu Wang, Tianjin (CN)

(21) Appl. No.: 14/320,893

(22) Filed: Jul. 1, 2014

(30) Foreign Application Priority Data
Jul. 2, 2013 (CN) 201310276072.4

(51) Int. Cl. F04C 23/02; H02K 3/34; H02K 3/12; F04C 18/02; H02K 3/02

(52) U.S. Cl. CPC F04C 23/02; F04C 18/0207; H02K 3/02; H02K 3/12; H02K 3/34
USPC 417/410.5; 417/410.1; 310/208

(57) ABSTRACT

The present invention provides a stator, a three-phase induction motor and a compressor. The stator is applied to a three-phase induction motor of a compressor. The stator includes: a stator iron core; a plurality of stator teeth extending inwards along a radial direction of the stator; stator slots distributed between the plurality of stator teeth; and three phases of windings wound around the stator teeth to generate a rotating magnetic field, where a coil of each phase of winding in the three phases of windings is made of a composite wire. The composite wire includes a wire core made of a first conductive metal material, and an outer layer wrapping an outer circumferential surface of the wire core and made of a second conductive metal material, wherein the first conductive metal material and the second conductive metal material have different electrical conductivities.

### CROSS REFERENCE TO RELATED APPLICATIONS

Applicant hereby claims foreign priority benefits under U.S.C. §119 from Chinese Patent Application Serial No. CN201310276072.4 filed on Jul. 2, 2013, the contents of which are incorporated by reference herein.

### FIELD OF THE INVENTION

The present invention relates to the technical field of air conditioning or refrigeration, and more particularly, to a stator, a three-phase induction motor, and a compressor.

### BACKGROUND OF THE INVENTION

A motor usually includes a stator installed inside a shell and a rotor installed inside the stator and supported on the shell to rotate relative to the stator. The stator and/or rotor of the motor have a winding including a coil. In the motor, electrical power is transmitted to pass through the coil to generate a magnetic field to enable the rotor to rotate. A motor, especially a three-phase induction motor, is usually used for driving a compressor (for example, a scroll-type compressor) used in the field of air conditioning or refrigeration. However, the size, performance, and cost of compressor apparatus including a motor usually affect the size and cost of air conditioning apparatus including the compressor apparatus significantly.

Currently, there are mainly improvements in the following two aspects for the foregoing problems.

As for efficiency improvement, a permanent-magnet motor is usually used in place of an induction motor to improve efficiency, or an optimization algorithm is used to optimize the design of a motor. However, by this way, the efficiency of a motor can only be improved to a limit, and it becomes very difficult to continue to improve the efficiency of a motor any more.

As for lower cost, an aluminum wire motor is used in place of a conventional copper wire motor. However, the use of an aluminum wire motor results in an excessive increase of the size of the motor, which is especially unsuitable for an application which has a limitation to the size of a motor.

### SUMMARY OF THE INVENTION

An objective of the present invention is to solve at least one aspect of the foregoing problems and defects that exist in the prior art.

An aspect of the present invention provides a stator used for a three-phase induction motor of a compressor, which includes: a stator iron core; a plurality of stator teeth extending inwards along a radial direction of the stator; stator slots distributed between the plurality of stator teeth; and three phases of windings wound around the stator teeth to generate a rotating magnetic field, where a coil of each phase of winding in the three phases of windings is made of a composite wire, where the composite wire includes a wire core made of a first conductive metal material, and an outer layer wrapping an outer circumferential surface of the wire core and made of a second conductive metal material, where the first conductive metal material and the second conductive metal material have different electrical conductivity.

In an embodiment of the present invention, the first conductive metal material is aluminum, and the second conductive metal material is copper or a copper alloy; or, the first conductive metal material is an aluminum alloy, and the second conductive metal material is copper or a copper alloy.

In addition, the composite wire further includes an insulating layer wrapping an outer circumferential surface of the outer layer.

When the first conductive metal material is aluminum and the second conductive metal material is copper, a volume ratio of copper to aluminum is (8 to 12):(92 to 88) or (13 to 17):(87 to 83).

In an embodiment, an outer diameter of the stator iron core ranges from 6 inches to 9 inches, an inner diameter is greater than or equal to 3.1 inches, and a ratio of the length of the stator iron core to the inner diameter of the stator iron core is 1.1 to 2.

In an example, the range of a cross-sectional area of the composite wire is 0.6 mm² to 1.5 mm².

In an example, a working voltage of the three-phase induction motor is smaller than or equal to 600 V.

Another aspect of the present invention provides a three-phase induction motor applied to a compressor, which includes a rotor and a stator, the rotor being rotatably disposed in the stator and is separated from the stator by a distance, where the stator is the above-mentioned stator.

Yet another aspect of the present invention provides a compressor, including a compression mechanism and the above-mentioned three-phase induction motor.

In an example, the compressor may be a scroll compressor.

As can be seen, the motor in accordance with embodiments of the present invention has a lower material cost while keeping the size of the motor, performance of the motor, reliability and manufacture the same or unchanged.

### BRIEF DESCRIPTION OF THE DRAWINGS

These and/or other aspects and advantages of the present invention will become clear and readily comprehensible through the description of preferred embodiments below with reference to the accompanying drawings, where:

FIG. 1 is a schematic view of a compressor using a three-phase induction motor according to an embodiment of the present invention;

FIG. 2 is a schematic cross-sectional view of a stator of a three-phase induction motor used in a compressor according to an embodiment of the present invention; and

FIG. 3 is a schematic view of a composite wire coil used in a winding in FIG. 2.

### DETAILED DESCRIPTION

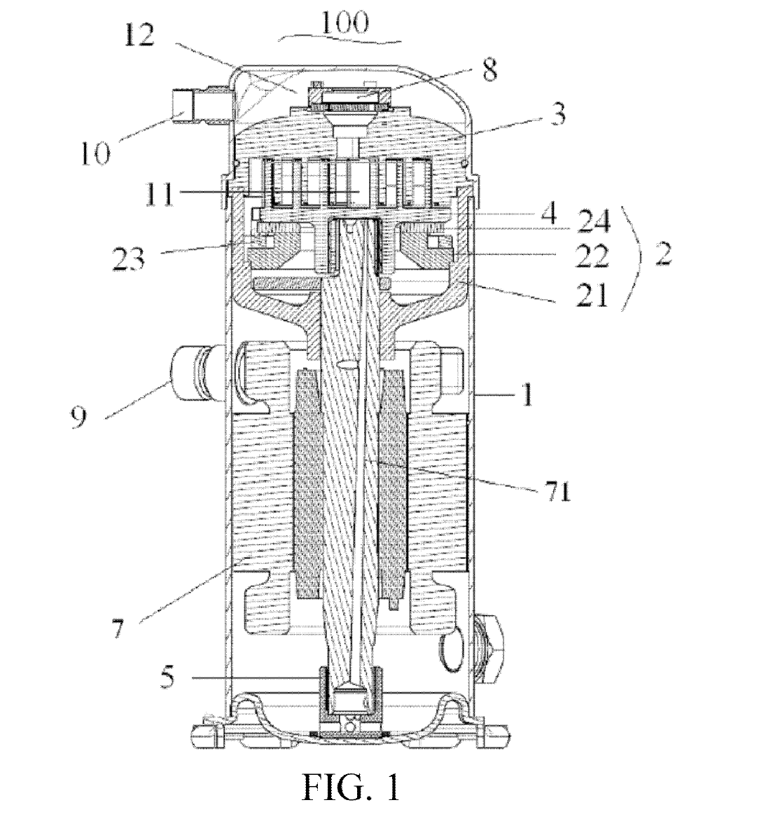

The technical solutions of the present invention are further specifically illustrated hereinafter through the embodiments with reference to the accompanying drawings FIG. 1 to FIG. 3. In the description, same or similar reference sings in the accompanying drawings refer to same or similar members. The following illustration of implementation manners of the present invention with reference to the accompanying drawings intends to explain technical solutions of the present invention, and should not be regarded as a limitation to the scope of the present invention.

Generally, a compressor may be used in the field of air conditioning or refrigeration. The compressor can convert mechanical energy into energy which is able to compress fluid or gas. The compressor may include a reciprocating compressor, a scroll-type compressor (i.e., scroll compressor), a centrifugal compressor, and a vane compressor.

Only a scroll compressor is used as an example below to illustrate arrangement and structure of a motor in the scroll compressor. It should be noted that the motor in accordance with embodiments of the present invention should not be limited to be used in the scroll compressor.

Typically, the working principle of a scroll compressor is that an orbiting scroll rotates around a base circle center of a fixed scroll, and the volume of a gas compression chamber formed by the orbiting scroll and the fixed scroll is gradually reduced to achieve an objective of gas compression. The orbiting scroll is directly supported on a support housing fixed to a shell of the compressor. In addition, one end (upper end) of a crankshaft used for driving the orbiting scroll to rotate is connected to the orbiting scroll through a central hole in the support housing, and the other end (lower end) of the crankshaft is directly supported on a lower support frame fixed inside the shell of the scroll compressor, so that when the crankshaft rotates in a clockwise or counterclockwise direction, corresponding gas suction, gas compression and gas discharge operations can be executed. The compressed gas may be discharged into a high-pressure cavity of the scroll compressor through a discharge valve, and may be eventually discharged through a discharge port.

As shown in FIG. 1, FIG. 1 shows a scroll compressor 100 according to an embodiment of the present invention. The scroll compressor 100 includes: a scroll compressor shell 1; a housing 2, the housing 2 being fixed inside the scroll compressor shell 1; a fixed scroll 3, fixed in the scroll compressor shell 1; an orbiting scroll 4, rotatably supported on the housing 2 and cooperating with the fixed scroll 3 to form a gas compression chamber 11; a lower support frame 5, fixed at a lower end of the compressor shell 1; a driving mechanism 7 such as a motor, fixed at a lower end of the scroll compressor 100 and transferring a rotational force through a crankshaft mechanism 71. An upper end of the crankshaft mechanism 71 is connected to the orbiting scroll 4 to drive the orbiting scroll 4 to rotate, and a lower end of the crankshaft mechanism 71 is supported on the lower support frame 5; and a discharge valve 8, used for discharging gas in the gas compression chamber 11 and preventing gas from flowing back into the scroll compressor 100.

The orbiting scroll 4 is supported on an upper surface or a support surface of the housing 2; the scroll compressor shell 1 defines a hermetic space inside, and accommodates the foregoing components such as the fixed scroll 3, the orbiting scroll 4 and the housing 2. A scroll wrap structure of the fixed scroll 3 and a scroll wrap structure of the orbiting scroll 4 are engaged or joined with each other to cooperate with each other to form the compression chamber 11. The fixed scroll 3 is arranged above the orbiting scroll 4. The motor 7 includes a stator and a rotor, and the motor 7 drives the orbiting scroll 4 by the crankshaft mechanism 71.

During operation of the scroll compressor 100, the scroll compressor 100 sucks in gas through a suction port 9. After the driving mechanism 7 (e.g., the motor) is started, the orbiting scroll 4 is driven by the crankshaft mechanism 71 and is constrained by an anti-rotation oldham coupling, and makes a rotary reverse movement with a small radius around a base circle center of the fixed scroll 3, so as to generate a high-pressure and high-temperature gas in the gas compression chamber 11 formed by the orbiting scroll 4 and the fixed scroll 3. The high-pressure and high-temperature gas may be discharged into the high-pressure cavity 12 through the discharge valve 8 with the movement of the orbiting scroll 4. The discharge valve 8 may be used to prevent the gas in the high-pressure cavity 12 from flowing back. Eventually, the gas in the high-pressure cavity 12 is discharged through a gas discharge port 10. The foregoing process is repeated, so as to generate a high-temperature and high-pressure gas in the scroll compressor 100 continuously.

In an embodiment of the present invention, the housing 2 may include a support body 21 and a support disk 22. In addition, the support body 21 may be fixed in the scroll compressor shell 1 in, e.g., an interference fit manner, and may be lapped over a shell end surface of the scroll compressor 100. The support disk 22 may be fixed on the support body 21 in, e.g., a gap fit manner, and may include a sliding slot which may be lapped over the support body 21, thereby fixing the support disk 22 and preventing the support disk 22 from rotating. An oldham coupling 23 may have an upper protrusion and a lower protrusion opposite each other and distributed in a cross shape, where the lower protrusion is inserted inside the sliding slot on the support disk 22, and the upper protrusion is inserted inside an ear slot of the orbiting scroll 4. As the scroll compressor 100 starts working, the orbiting scroll 4 can orbit with a small radius relative to the support disk 22.

If necessary (for example, when a support area, for supporting the orbiting scroll 4, of the support disk 22 is not large enough), a thrust bearing disk 24 may be further disposed between the orbiting scroll 4 and the oldham coupling 23 to increase the support area for the orbiting scroll 4, and the thrust bearing disk 24 may be fixed in an interference fit manner and may be lapped over the support disk 22 and support the orbiting scroll 4.

A compression principle and compression operations of the scroll compressor 100 will not be described in detail here.

As shown in FIG. 1, the motor used for the compressor is usually a three-phase induction motor. However, it should be understood that the motor is not limited to the three-phase induction motor in accordance with an embodiment of the present invention. The three-phase induction motor shown here is only an example, and the concept of the present invention can be used for any other types of motors, as long as it is feasible. In addition, the three-phase induction motor is not limited to the scroll compressor shown in FIG. 1, but can also be applied to other types of compressors.

The three-phase motor or three-phase induction motor usually includes a stator, a rotor, and some other relevant members (such as a shell). A stator of a three-phase induction motor is improved in the embodiments of the present invention. During manufacture and design of a three-phase induction motor, the improved stator may be used in the three-phase induction motor.

Generally, the three-phase induction motor mainly includes a rotor and a stator, and the rotor is rotatably arranged in the stator and is separated from the stator by a distance.

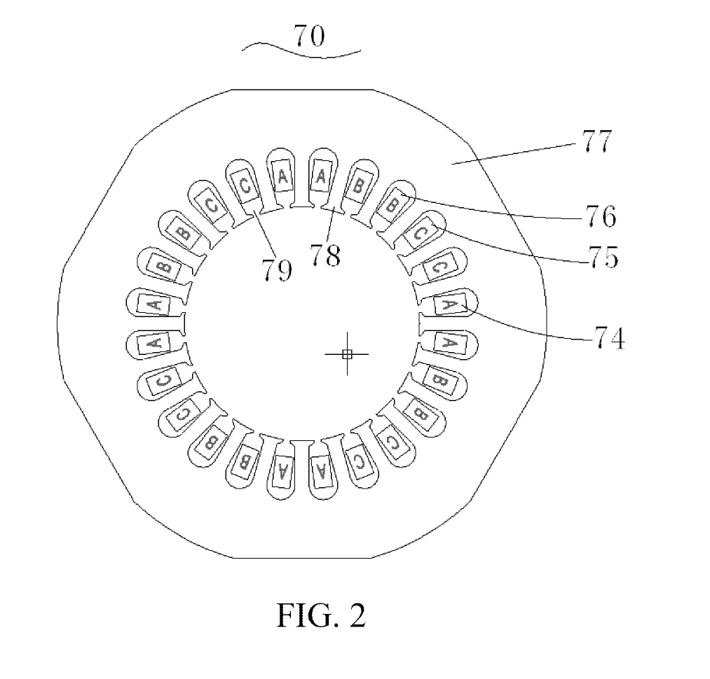

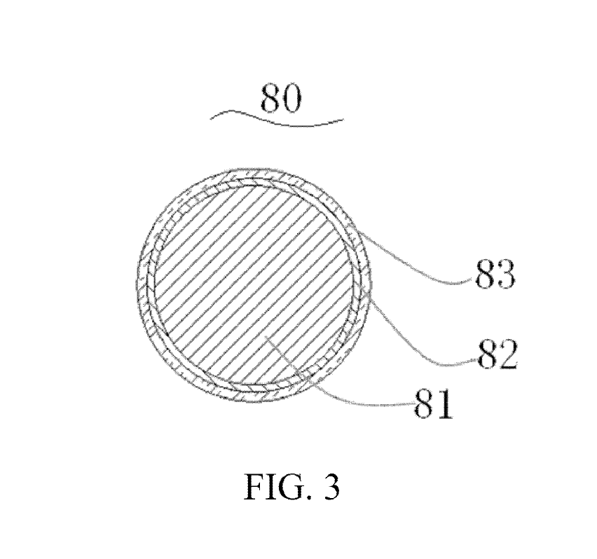

Specifically, as shown in FIG. 2 and FIG. 3, the stator 70 includes: a stator iron core 77; a plurality of stator teeth 78 extending inwards along a radial direction of the stator 70; stator slots 79 distributed between the plurality of stator teeth 78; and three-phase windings 74, 75, 76 (also shown as phase-A, phase-B, and phase-C windings, and specifically, in an example, may be three phases of windings sequentially separated in space by an electric angle of 120°) wound around the stator teeth 78 to generate a rotating magnetic field. A coil of each phase of winding (for example, a phase-A winding, a phase-B winding or a phase-C winding) is made of a composite wire 80. The composite wire 80 includes a wire core 81 made of a first conductive metal material and an outer layer 82 wrapping an outer circumferential surface of the wire core 81 and made of a second conductive metal material. The first conductive metal material and the second conductive metal material have different electrical conductivities. In an embodiment, the first conductive metal material may be aluminum, and the second conductive metal material may be copper or a copper alloy. Alternatively, the first conductive metal material may be an aluminum alloy, and the second conductive metal material may be copper or a copper alloy. The composite wire 80 may further include an insulating layer 83 wrapping an outer circumferential surface of the outer layer 82. In an embodiment, the stator iron core 77 may have a cylindrical shape, or have other shapes suitable for a stator iron core of a three-phase motor. In an embodiment, the insulating layer 83 may be insulating paint. Alternatively, the insulating layer 83 may also be in another form or be made of other materials.

In an embodiment of the present invention, when the first conductive metal material of the composite wire 80 is aluminum and the second conductive metal material of the composite wire 80 is copper, a volume ratio of copper to aluminum may be (8 to 12):(92 to 88), or (13 to 17):(87 to 83).

An outer diameter of the stator iron core 77 may be ranged from 6 to 9 inches, an inner diameter of the stator iron core 77 is larger than or equal to 3.1 inches, and a ratio of the length of the stator iron core 77 to the inner diameter of the stator iron core 77 is 1.1 to 2. A cross-sectional area of the composite wire 80 ranges from 0.6 mm² to 1.5 mm². Alternatively, persons skilled in the art may select suitable sizes for the stator iron core 77 and the composite wire 80 without departing from the spirit and scope of the present invention.

According to an embodiment, a working voltage of the three-phase induction motor is smaller than or equal to 600 V.

The composite wire 80 in the embodiments of the present invention, if it has the same direct current resistance as a copper conductor, can achieve the following advantages: 1) a thermal circulation index ratio between the conductors of the composite wire 80 and a connecting terminal is better than thermal circulation index between copper and the connecting terminal; 2) the composite wire 80 can be welded with tin as easily as copper; 3) the contact resistance of the composite wire 80 is the same as that of copper; 4) resistance of the composite wire 80 may be adjusted by adjusting a conductor cross-section and copper content; and 5) the density is smaller than that of a pure copper wire and is only 36% to 42% of a pure copper wire. In addition, the composite wire 80 in the embodiment of the present invention may overcome the disadvantages of an aluminum conductor, including high resistance, low strength, and high susceptibility to creep, corrosion and oxidation.

As can be seen from the analysis above, in the embodiments of the present invention, the stator with the composite wire 80 combines advantages of a copper wire coil and an aluminum wire coil, has a lower material cost and improves reliability and a manufacture process of a motor with the stator. Meanwhile, embodiments of the present invention also overcome a disadvantage that the size of a pure aluminum wire motor is too large.

The foregoing only provides some embodiments of the present invention, and persons of ordinary skill in the art shall understand that changes may be made to these embodiments without departing from the principle and spirit of the general inventive concept; the scope of the present invention is defined by the claims and their equivalents.

What is claimed is:

1. A stator applied to a three-phase induction motor of a compressor, comprising:
a stator iron core;
a plurality of stator teeth extending inwards along a radial direction of the stator;
stator slots distributed between the plurality of stator teeth; and
three phases of windings wound around the stator teeth to generate a rotating magnetic field, wherein
a coil of each phase of winding among the three phases of windings is made of a composite wire, and the composite wire comprises a wire core made of a first conductive metal material, and an outer layer wrapping an outer circumferential surface of the wire core and made of a second conductive metal material, wherein the first conductive metal material and the second conductive metal material have different electrical conductivities.

2. The stator according to claim 1, wherein
the first conductive metal material is aluminum, and the second conductive metal material is copper or a copper alloy; or,
the first conductive metal material is an aluminum alloy, and the second conductive metal material is copper or a copper alloy.

3. The stator according to claim 1, wherein
the composite wire further comprises an insulating layer wrapping an outer circumferential surface of the outer layer.

4. The stator according to claim 2, wherein the composite wire further comprises an insulating layer wrapping an outer circumferential surface of the outer layer.

5. The stator according to claim 2, wherein
when the first conductive metal material is aluminum and the second conductive metal material is copper, a ratio of a volume of the copper to a volume of the aluminum is (8 to 12):(92 to 88) or (13 to 17):(87 to 83).

6. The stator according to claim 5, wherein
an outer diameter of the stator iron core ranges from 6 inches to 9 inches, an inner diameter of the stator iron core is greater than or equal to 3.1 inches, and a ratio of a length of the stator iron core to the inner diameter of the stator iron core is 1.1 to 2.

7. The stator according to claim 6, wherein
a cross-sectional area of the composite wire ranges from 0.6 mm² to 1.5 mm².

8. The stator according to claim 7, wherein
a working voltage of the three-phase induction motor is smaller than or equal to 600 V.

9. A three-phase induction motor applied to a compressor, comprising a rotor and a stator, the rotor being rotatably disposed in the stator and is separated from the stator by a distance, wherein the stator comprises:
a stator iron core;
a plurality of stator teeth extending inwards along a radial direction of the stator;
stator slots distributed between the plurality of stator teeth; and
three phases of windings wound around the stator teeth to generate a rotating magnetic field, wherein a coil of each phase of winding among the three phases of windings is made of a composite wire, and the composite wire comprises a wire core made of a first conductive metal material, and an outer layer wrapping an outer circumferential surface of the wire core and made of a second conductive metal material, wherein the first conductive metal material and the second conductive metal material have different electrical conductivities.

10. The three-phase induction motor according to claim 9, wherein the first conductive metal material is aluminum, and the second conductive metal material is copper or a copper alloy; or, the first conductive metal material is an aluminum alloy, and the second conductive metal material is copper or a copper alloy.

11. The three-phase induction motor according to claim 10, wherein the composite wire further comprises an insulating layer wrapping an outer circumferential surface of the outer layer.

12. The three-phase induction motor according to claim 11, when the first conductive metal material is aluminum and the second conductive metal material is copper, a ratio of a volume of the copper to a volume of the aluminum is (8 to 12):(92 to 88) or (13 to 17):(87 to 83).

13. The three-phase induction motor according to claim 12, wherein a working voltage of the three-phase induction motor is smaller than or equal to 600 V

14. A compressor, comprising a compression mechanism and a three-phase induction motor; wherein the three-phase induction motor comprises a rotor and a stator, the rotor being rotatably disposed in the stator and is separated from the stator by a distance; wherein the stator comprises:
a stator iron core;
a plurality of stator teeth extending inwards along a radial direction of the stator;
stator slots distributed between the plurality of stator teeth; and
three phases of windings wound around the stator teeth to generate a rotating magnetic field, wherein a coil of each phase of winding among the three phases of windings is made of a composite wire, and the composite wire comprises a wire core made of a first conductive metal material, and an outer layer wrapping an outer circumferential surface of the wire core and made of a second conductive metal material, wherein the first conductive metal material and the second conductive metal material have different electrical conductivities.

15. The compressor according to claim 14, wherein the compressor is a scroll compressor.
